(19) United States
(12) Patent Application Publication
(10) Pub. No.: US 2025/0296882 A1
(43) Pub. Date: Sep. 25, 2025

(54) TIN BORATE MICROWAVE DIELECTRIC CERAMIC WITH NEAR-ZERO TEMPERATURE COEFFICIENT AND PREPARATION METHOD THEREOF

(71) Applicant: QILU UNIVERSITY OF TECHNOLOGY (SHANDONG ACADEMY OF SCIENCES), Shandong (CN)

(72) Inventors: Feng SHI, Shandong (CN); Yingbo YU, Shandong (CN); Fuzhou SONG, Shandong (CN); Jingxuan DONG, Shandong (CN); Shuai LV, Shandong (CN); Yue XU, Shandong (CN); Lingcui ZHANG, Shandong (CN); Yan SHEN, Shandong (CN); Jinbo ZHAO, Shandong (CN)

(21) Appl. No.: 19/052,081

(22) Filed: Feb. 12, 2025

(30) Foreign Application Priority Data
Mar. 19, 2024 (CN) 202410311504.9

(51) Int. Cl. C04B 35/01; C04B 35/626; C04B 35/645

(52) U.S. Cl. CPC C04B 35/01; C04B 35/62615; C04B 35/62655; C04B 35/62675; C04B 35/645; C04B 2235/3232; C04B 2235/3293; C04B 2235/3409; C04B 2235/442; C04B 2235/6567; C04B 2235/662

(57) ABSTRACT

Provided are a tin borate microwave dielectric ceramic with a near-zero temperature coefficient and a preparation method thereof. The tin borate microwave dielectric ceramic with the near-zero temperature coefficient has a chemical formula of (1−x)BaSn(BO₃)₂−xTiO₂, x being in a range of 0.05 to 0.25; where a principal crystalline phase of the tin borate microwave dielectric ceramic with the near-zero temperature coefficient has a chemical formula of BaSn(BO₃)₂.

### CROSS REFERENCE TO RELATED APPLICATION

This patent application claims the benefit and priority of Chinese Patent Application No. 2024103115049 filed with the China National Intellectual Property Administration on Mar. 19, 2024, the disclosure of which is incorporated by reference herein in its entirety as part of the present application.

### TECHNICAL FIELD

The present disclosure relates to the technical field of microwave dielectric ceramics, and in particular to a tin borate microwave dielectric ceramic with a near-zero temperature coefficient and a preparation method thereof.

### BACKGROUND

Wireless communication technology has developed rapidly in recent years, with increasing demand for data transmission speed and efficiency. Not only the study of the mobility, portability, and miniaturization of communication devices but also the improvement of the rate of communication carriers are required. This requires the development of materials suitable for high-reliability and high-performance microwave frequency bands. Microwave dielectric ceramics are essential materials in fields such as dielectric resonators, filters and antennas, showing significant potential in the next generation of communication technologies. The dielectric ceramic with a low dielectric constant (εᵣ), a high quality factor, and a near-zero resonance frequency temperature coefficient (τ_{f}) can shorten the transmission time of signals and enable the high-speed and stable transmission of signals, which will also provide a solid hardware foundation for 5G or potential 6G communication systems.

A characteristic of tin borate microwave dielectric ceramics is their extremely low dielectric constant, which makes them highly valuable for applications in 5G and even 6G communication. In previous studies, microwave dielectric ceramics are mostly prepared by using a solid-phase method. However, the solid-phase method has a high sintering temperature, and borates are easily decomposed at a high temperature, making it difficult to form microwave dielectric ceramics.

Cold sintering process allows the application of a uniaxial pressure to the material while heating, promoting the flow and mass transfer of the solution in the ceramic powder to achieve rapid densification, and avoiding problems such as raw material volatilization or abnormal grain growth caused by high temperature in traditional sintering methods.

Chinese patent, with a publication number CN 116199498 A, discloses a borate microwave dielectric ceramic with a low dielectric constant and a cold sintering preparation method thereof. Although a borate microwave dielectric ceramic is obtained at a lower temperature, the resulting borate microwave dielectric ceramic has a resonant frequency temperature coefficient of −28.62 ppm·° C.⁻¹ to −15.98 ppm·° C.⁻¹, which needs to be further optimized.

### SUMMARY

In view of this, an object of the present disclosure is to provide a tin borate microwave dielectric ceramic with a near-zero temperature coefficient and a preparation method thereof.

The tin borate microwave dielectric ceramic with the near-zero temperature coefficient has a resonance frequency temperature coefficient closer to zero, thus exhibiting superior performance.

In order to achieve the object described above, the present disclosure provides the following technical solutions.

The present disclosure provides a tin borate microwave dielectric ceramic with a near-zero temperature coefficient, having a chemical formula of (1−x)BaSn(BO₃)₂−xTiO₂, x being in a range of 0.05 to 0.25;

where a principal crystalline phase of the tin borate microwave dielectric ceramic with the near-zero temperature coefficient has a chemical formula of BaSn(BO₃)₂.

In some embodiments, the tin borate microwave dielectric ceramic with the near-zero temperature coefficient has a resonant frequency temperature coefficient of −7 ppm·° C.⁻¹ to 7 ppm·° C.⁻¹, a dielectric constant of 3.97 to 5.48, and a quality factor of 10,836 to 13,065.

The present disclosure further provides a method for preparing the tin borate microwave dielectric ceramic with the near-zero temperature coefficient according to the technical solution above, including the following steps:
subjecting B₂O₃, SnO₂, and BaCO₃ to first mixing, and pre-sintering a resulting mixture to obtain a BaSn(BO₃)₂ powder; and
subjecting the BaSn(BO₃)₂ powder and TiO₂ to second mixing, and subjecting a resulting mixture to cold sintering and annealing in sequence to obtain the tin borate microwave dielectric ceramic with the near-zero temperature coefficient.

In some embodiments, the first mixing comprises conducting wet ball milling, drying, and sieving in sequence; and
the wet ball milling is conducted under parameters including: a ratio of a total mass of the B₂O₃, the SnO₂, and the BaCO₃, a mass of a zirconia ball, and a mass of absolute ethanol in a range of 1:3:2 to 1:3:2.8, a rotation speed for the wet ball milling in a range of 380 rpm to 400 rpm, and a time for the wet ball milling in a range of 6 h to 8 h.

In some embodiments, the pre-sintering is conducted at a temperature of 875° C. to 950° C. for 6 h to 8 h.

In some embodiments, before the second mixing, the method further includes: subjecting the BaSn(BO₃)₂ powder to wet ball milling, drying, and sieving in sequence to obtain a undersize material passing through a screen.

In some embodiments, the second mixing includes: mixing the BaSn(BO₃)₂ powder, the TiO₂, and water by grinding.

In some embodiments, the cold sintering is conducted at a temperature of 250° C. to 300° C. and a pressure of 450 MPa to 700 MPa for 25 min to 40 min.

In some embodiments, the annealing is conducted at a temperature of 600° C. to 750° C. for 2 h to 4 h.

In some embodiments, after the annealing, the method further includes: cooling a resulting annealed product to room temperature, and grinding and polishing the resulting annealed product.

The present disclosure provides a tin borate microwave dielectric ceramic with a near-zero temperature coefficient, having a chemical formula of (1−x)BaSn(BO₃)₂−xTiO₂, x being in a range of 0.05 to 0.25; where a principal crystalline phase of the tin borate microwave dielectric ceramic with the near-zero temperature coefficient has a chemical formula of BaSn(BO₃)₂.

The tin borate microwave dielectric ceramic with the near-zero temperature coefficient belongs to the trigonal system. In BaSn(BO₃)₂, Ba²⁺ and Sn²⁺ ions form [BaO₆] and [SnO₆] octahedra with six surrounding O²⁻ ions, respectively. It also can be seen that the crystal structure of BaSn(BO₃)₂ is a layered structure consisting of [BaO₆] octahedra, [SnO₆] octahedra, and a [BO₃] planar triangle (B is located in the center of a regular triangle consisting of three oxygen atoms). In this unit cell structure, a plurality of [BaO₆] octahedra form a first layer, the [SnO₆] octahedra form a second layer, and the two layers are connected by shared oxygen atoms at the vertexes. TiO₂ consists of TiO₆ polyhedra, which is of a tetragonal rutile structure. The value of the τ_{f} of TiO₂ is +460 ppm/° C. By adding TiO₂, the resonant frequency temperature coefficient of the ceramic can be adjusted and controlled to near zero while ensuring excellent dielectric properties. Finally, the tin borate microwave dielectric ceramic with the near-zero temperature coefficient can be prepared at a low temperature (≤300° C.) within a short period of time, which greatly reduces the difficulty of adjusting and controlling the sintering process, reduces energy consumption and environmental pollution, improves production efficiency, and is of great significance for production and applications.

The data from the examples indicate that, the tin borate microwave dielectric ceramic with the near-zero temperature coefficient has a resonance frequency temperature coefficient of −7 ppm·° C.⁻¹ to 7 ppm·° C.⁻¹, closer to zero, and thus has a better performance than those in the prior art. In some embodiments of the present disclosure, the tin borate microwave dielectric ceramic with the near-zero temperature coefficient has a dielectric constant of 3.97 to 5.48, and a quality factor of 10,836 to 13,065.

The present disclosure further provides a method for preparing the tin borate microwave dielectric ceramic with the near-zero temperature coefficient according to the technical solution above. The method shows low energy consumption, minimal environmental pollution, and high production efficiency.

### BRIEF DESCRIPTION OF THE DRAWINGS

FIG. 1 shows the XRD patterns of the (1−x)BaSn(BO₃)₂−xTiO₂ microwave dielectric ceramics of Examples 1 to 5 in the present disclosure;

FIG. 2 shows the microwave dielectric property profiles of the (1−x)BaSn(BO₃)₂−xTiO₂ microwave dielectric ceramics of Examples 1 to 5 in the present disclosure; and

FIG. 3A, FIG. 3B, FIG. 3C, FIG. 3D, and FIG. 3E show the scanning electron microscopy (SEM) images of the (1−x)BaSn(BO₃)₂−xTiO₂ microwave dielectric ceramics of Examples 1 to 5 in the present disclosure.

### DETAILED DESCRIPTION OF THE EMBODIMENTS

The present disclosure provides a tin borate microwave dielectric ceramic with a near-zero temperature coefficient, having a chemical formula of (1−x)BaSn(BO₃)₂−xTiO₂, x being in a range of 0.05 to 0.25;
where a principal crystalline phase of the tin borate microwave dielectric ceramic with the near-zero temperature coefficient has a chemical formula of BaSn(BO₃)₂.

In some embodiments of the present disclosure, the x is in a range of 0.1 to 0.2, specifically 0.05, 0.1, 0.15, 0.2, or 0.25.

In some embodiments of the present disclosure, the tin borate microwave dielectric ceramic with the near-zero temperature coefficient has a resonance frequency temperature coefficient of −7 ppm·° C.⁻¹ to 7 ppm·° C.⁻¹, closer to zero, and thus has a better performance than those in the prior art. In some embodiments of the present disclosure, the tin borate microwave dielectric ceramic with the near-zero temperature coefficient has a dielectric constant of 3.97 to 5.48, and a quality factor of 10,836 to 13,065.

The present disclosure further provides a method for preparing the tin borate microwave dielectric ceramic with the near-zero temperature coefficient according to the technical solution above, including the following steps:
subjecting B₂O₃, SnO₂, and BaCO₃ to first mixing, and pre-sintering a resulting mixture to obtain a BaSn(BO₃)₂ powder; and
subjecting the BaSn(BO₃)₂ powder and TiO₂ to second mixing, and subjecting a resulting mixture to cold sintering and annealing in sequence to obtain the tin borate microwave dielectric ceramic with the near-zero temperature coefficient.

In some embodiments of the present disclosure, unless otherwise specified, the raw materials used in some embodiments of the present disclosure are commercially available products.

In the present disclosure, B₂O₃, SnO₂ and BaCO₃ are subjected to first mixing, and a resulting mixture is subjected to pre-sintering to obtain a BaSn(BO₃)₂ powder.

In some embodiments of the present disclosure, the B₂O₃ has a purity of ≥98%, and preferably 98%. In some embodiments of the present disclosure, the SnO₂ has a purity of ≥99.5%, and preferably 99.5%. In some embodiments of the present disclosure, the BaCO₃ has a purity of ≥99%, and preferably 99%.

In some embodiments of the present disclosure, before the first mixing of the B₂O₃, the SnO₂, and the BaCO₃, the method further includes drying; and the drying is conducted at a temperature of 100° C. for 24 h in an oven.

In some embodiments of the present disclosure, the first mixing comprises conducting wet ball milling, drying, and sieving in sequence. In some embodiments of the present disclosure, the wet ball milling is conducted under parameters including: a ratio of a total mass of the B₂O₃, the SnO₂, and the BaCO₃, a mass of a zirconia ball, and a mass of absolute ethanol in a range of 1:3:2 to 1:3:2.8, preferably 1:3:2.5; a rotation speed for the wet ball milling in a range of 380 rpm to 400 rpm; and a time for the wet ball milling in a range of 6 h to 8 h. In some embodiments of the present disclosure, the drying is conducted at a temperature of 80° C. In the present disclosure, the duration for the drying is not specifically limited, and the drying continues until a constant weight is achieved. In some embodiments of the present disclosure, the drying is conducted in an oven. In some embodiments of the present disclosure, a mesh size of a screen for the sieving is 80 mesh; and after the sieving, a undersize material passing through the screen is obtained.

In some embodiments of the present disclosure, the pre-sintering is conducted at a temperature of 875° C. to 950° C., preferably 900° C., for 6 h to 8 h.

In the present disclosure, after obtaining the BaSn(BO₃)₂ powder, the BaSn(BO₃)₂ powder and TiO₂ are subjected to second mixing, and a resulting mixture is subjected to cold sintering and annealing in sequence to obtain the tin borate microwave dielectric ceramic with the near-zero temperature coefficient.

In some embodiments of the present disclosure, before the second mixing of the BaSn(BO₃)₂powder and the TiO₂, the method further includes: subjecting the BaSn(BO₃)₂ powder to wet ball milling, drying, and sieving in sequence to obtain a undersize material passing through a screen. In some embodiments of the present disclosure, the wet ball milling is conducted under parameters including: using a reagent of absolute ethanol, at a rotation speed in a range of 380 rpm to 400 rpm, and for a period of 6 h. In some embodiments of the present disclosure, the drying is conducted at a temperature of 80° C. In the present disclosure, the temperature for the drying is not specifically limited, and the drying continues until a constant weight is achieved. In some embodiments of the present disclosure, the drying is conducted in an oven. In some embodiments of the present disclosure, a mesh size of a screen for the sieving is 80 mesh.

In some embodiments of the present disclosure, the second mixing includes: mixing the BaSn(BO₃)₂ powder, the TiO₂, and water by grinding. In the present disclosure, the parameters for the grinding is not specifically limited, as long as the BaSn(BO₃)₂ powder could be fully mixed with TiO₂.

In some embodiments of the present disclosure, the cold sintering is conducted at a temperature of 250° C. to 300° C., preferably 270° C., and a pressure of 450 MPa to 700 MPa, preferably 550 MPa for 25 min to 40 min, preferably 30 min. In some embodiments of the present disclosure, the cold sintering is conducted in a hot press.

In some embodiments of the present disclosure, the annealing is conducted at a temperature of 600° C. to 750° C., preferably 750° C., for 2 h to 4 h, preferably 3 h; and the annealing is conducted in a muffle furnace.

In some embodiments of the present disclosure, after the annealing, the method further includes cooling a resulting annealed product to room temperature, and grinding and polishing the resulting annealed product.

The tin borate microwave dielectric ceramic with the near-zero temperature coefficient and the preparation method thereof provided by the present disclosure will be described in detail below in conjunction with the examples, which cannot be construed as limiting the scope of the present disclosure.

### Example 1

A microwave dielectric ceramic (1−x)BaSn(BO₃)₂−xTiO₂ (x=0.05) in this example was prepared by a method as follows:
(1) Preparing raw materials: raw materials of B₂O₃(Macklin, 98%), SnO₂ (Macklin, 99.5%), and BaCO₃ (Macklin, 99%) were dried in an oven at 100° C. and then weighed according to the stoichiometric ratio.
(2) Mixing: a resulting prepared raw material, a zirconia ball, and absolute ethanol in a mass ratio of 1:3:2.5 were placed in a ball mill and wet ball milled at a rotation speed of 400 rpm for 6 h to obtain a raw material slurry.
(3) Drying: the raw material slurry obtained in step (2) was placed in an oven and then dried to a constant weight under a condition of 80° C. to obtain a dry mixed material.
(4) Pre-sintering: the dry mixed material obtained in step (3) was passed through an 80 mesh screen and then placed in a muffle furnace and pre-sintered at a temperature of 900° C. for 6 h to obtain a BaSn(BO₃)₂ powder.
(5) Ball milling: the BaSn(BO₃)₂ powder obtained in step (4) was added to absolute ethanol and placed into a ball mill, and subjected to secondary grinding at 400 rpm for 6 h to obtain a BaSn(BO₃)₂ slurry.
(6) Drying: the BaSn(BO₃)₂ slurry obtained in step (5) was placed in an oven and then dried to a constant weight under a condition of 80° C. to obtain a BaSn(BO₃)₂ powder.
(7) Solvent mixing: the BaSn(BO₃)₂ powder obtained in step (6) was passed through an 80 mesh standard sieve, and a resulting undersize material was mixed with TiO₂ in a mortar according to a ratio (1−x)BaSn(BO₃)₂−xTiO₂ (x=0.05). Then distilled water was added thereto, followed by full grinding of a resulting mixture until uniform, and then a resulting slurry was poured into a cylindrical mold.
(8) Sintering: the cylindrical mold obtained in step (7) was placed in a hot press and then sintered at a pressure of 550 MPa and a temperature of 270° C. for 30 min to obtain a (1−x)BaSn(BO₃)₂−xTiO₂ (x=0.05) microwave dielectric ceramic.
(9) Annealing: the (1−x)BaSn(BO₃)₂−xTiO₂ (x=0.05) ceramic obtained in step (8) was placed in a muffle furnace and maintained at 750° C. for 3 h, and then automatically cooled to room temperature.
(10) Postmechanical processing: a surface of a resulting sintered microwave dielectric ceramic (1−x)BaSn(BO₃)₂−xTiO₂ (x=0.05) was ground and polished.

### Example 2

A microwave dielectric ceramic (1−x)BaSn(BO₃)₂−xTiO₂ (x=0.1) in this example was prepared by a method as follows:
(1) Preparing raw materials: raw materials of B₂O₃(Macklin, 98%), SnO₂ (Macklin, 99.5%), and BaCO₃ (Macklin, 99%) were dried in an oven at 100° C. and then weighed according to the stoichiometric ratio.
(2) Mixing: a resulting prepared raw materials, a zirconia ball, and absolute ethanol in a mass ratio of 1:3:2.5 were placed in a ball mill and wet ball milled at a rotation speed of 400 rpm for 6 h to obtain a raw material slurry.
(3) Drying: the raw material slurry obtained in step (2) was placed in an oven and then dried to a constant weight under a condition of 80° C. to obtain a dry mixed material.
(4) Pre-sintering: the dry mixed material in step (3) was passed through an 80 mesh screen and then placed in a muffle furnace and pre-sintered at a temperature of 900° C. for 6 h to obtain a BaSn(BO₃)₂ powder.
(5) Ball milling: the BaSn(BO₃)₂ powder obtained in step (4) was added to absolute ethanol and placed in a ball mill, and subjected to secondary grinding at 400 rpm for 6 h to obtain a BaSn(BO₃)₂ slurry.
(6) Drying: the BaSn (BO₃)₂ slurry obtained in step (5) was placed in an oven and then dried to a constant weight under a condition of 80° C. to obtain a BaSn(BO₃)₂ powder.
(7) Solvent mixing: the BaSn(BO₃)₂ powder obtained in step (6) was passed through an 80 mesh standard sieve, and a resulting undersize material was mixed with TiO₂ in a mortar according to a ratio (1−x)BaSn(BO₃)₂−xTiO₂ (x=0.1). Then distilled water was added thereto, followed by full grinding of a resulting mixture until uniform, and then a resulting slurry was poured into a cylindrical mold.
(8) Sintering: the cylindrical mold obtained in step (7) was placed in a hot press and then sintered at a pressure of 550 MPa and a temperature of 270° C. for 30 min to obtain a (1−x)BaSn(BO₃)₂−xTiO₂ (x=0.1) microwave dielectric ceramic.
(9) Annealing: the (1−x)BaSn(BO₃)₂−xTiO₂ (x=0.1) ceramic obtained in step (8) was placed in a muffle furnace and maintained at 750° C. for 3 h, and then automatically cooled to room temperature.
(10) Postmechanical processing: a surface of a resulting sintered microwave dielectric ceramic (1−x)BaSn(BO₃)₂−xTiO₂ (x=0.1) was ground and polished.

### Example 3

A microwave dielectric ceramic (1−x)BaSn(BO₃)₂−xTiO₂ (x=0.15) in this example was prepared by a method as follows:
(1) Preparing raw materials: raw materials of B₂O₃(Macklin, 98%), SnO₂ (Macklin, 99.5%), and BaCO₃ (Macklin, 99%) were dried in an oven at 100° C. and then weighed according to the stoichiometric ratio.
(2) Mixing: a resulting prepared raw materials, a zirconia ball, and absolute ethanol in a mass ratio of 1:3:2.5 were placed in a ball mill and wet ball milled at a rotation speed of 400 rpm for 6 h to obtain a raw material slurry.
(3) Drying: the raw material slurry obtained in step (2) was placed in an oven and then dried to a constant weight under a condition of 80° C. to obtain a dry mixed material.
(4) Pre-sintering: the dry mixed material obtained in step (3) was passed through an 80 mesh screen and then placed in a muffle furnace and pre-sintered at a temperature of 900° C. for 6 h to obtain a BaSn(BO₃)₂ powder.
(5) Ball milling: the BaSn(BO₃)₂ powder obtained in step (4) was added to absolute ethanol and placed in a ball mill, and subjected to secondary grinding at 400 rpm for 6 h to obtain a BaSn(BO₃)₂ slurry.
(6) Drying: the BaSn (BO₃)₂ slurry obtained in step (5) was placed in an oven and then dried to a constant weight under a condition of 80° C. to obtain a BaSn(BO₃)₂ powder.
(7) Solvent mixing: the BaSn(BO₃)₂ powder obtained in step (6) was passed through an 80 mesh standard sieve, and a resulting undersize material was mixed with TiO₂ in a mortar according to a ratio (1−x)BaSn(BO₃)₂−xTiO₂ (x=0.15). Then distilled water was added thereto, followed by full grinding of a resulting mixture until uniform, and then a resulting slurry was poured into a cylindrical mold.
(8) Sintering: the cylindrical mold obtained in step (7) was placed in a hot press and then sintered at a pressure of 550 MPa and a temperature of 270° C. for 30 min to obtain a (1−x)BaSn(BO₃)₂−xTiO₂ (x=0.15) microwave dielectric ceramic.
(9) Annealing: the (1−x)BaSn(BO₃)₂−xTiO₂ (x=0.15) ceramic obtained in step (8) was placed in a muffle furnace and maintained at 750° C. for 3 h, and then automatically cooled to room temperature.
(10) Postmechanical processing: a surface of a resulting sintered microwave dielectric ceramic (1−x)BaSn(BO₃)₂−xTiO₂ (x=0.15) was ground and polished.

### Example 4

A microwave dielectric ceramic (1−x)BaSn(BO₃)₂−xTiO₂ (x=0.2) in this example was prepared by a method as follows:
(1) Preparing raw materials: raw materials of B₂O₃(Macklin, 98%), SnO₂ (Macklin, 99.5%), and BaCO₃ (Macklin, 99%) were dried in an oven at 100° C. and then weighed according to the stoichiometric ratio.
(2) Mixing: a resulting prepared raw materials, a zirconia ball, and absolute ethanol in a mass ratio of 1:3:2.5 were placed in a ball mill and wet ball milled at a rotation speed of 400 rpm for 6 h to obtain a raw material slurry.
(3) Drying: the raw material slurry obtained in step (2) was placed in an oven and then dried to a constant weight under a condition of 80° C. to obtain a dry mixed material.
(4) Pre-sintering: the dry mixed material obtained in step (3) was passed through an 80 mesh screen and then placed in a muffle furnace and pre-sintered at a temperature of 900° C. for 6 h to obtain a BaSn(BO₃)₂ powder.
(5) Ball milling: the BaSn(BO₃)₂ powder obtained in step (4) was added to absolute ethanol and placed in a ball mill, and subjected to secondary grinding at 400 rpm for 6 h to obtain a BaSn(BO₃)₂ slurry.
(6) Drying: the BaSn (BO₃)₂ slurry obtained in step (5) was placed in an oven and then dried to a constant weight under a condition of 80° C. to obtain a BaSn(BO₃)₂ powder.
(7) Solvent mixing: the BaSn(BO₃)₂ powder obtained in step (6) was passed through an 80 mesh standard sieve, and a resulting undersize material was mixed with TiO₂ in a mortar according to a ratio (1−x)BaSn(BO₃)₂−xTiO₂ (x=0.2). Then distilled water was added thereto, followed by full grinding of a resulting mixture until uniform, and then a resulting slurry was poured into a cylindrical mold.
(8) Sintering: the cylindrical mold obtained in step (7) was placed in a hot press and then sintered at a pressure of 550 MPa and a temperature of 270° C. for 30 min to obtain a (1−x)BaSn(BO₃)₂−xTiO₂ (x=0.2) microwave dielectric ceramic.
(9) Annealing: the (1−x)BaSn(BO₃)₂−xTiO₂ (x=0.2) ceramic obtained in step (8) was placed in a muffle furnace and maintained at 750° C. for 3 h, and then automatically cooled to room temperature.
(10) Postmechanical processing: a surface of a resulting sintered microwave dielectric ceramic (1−x)BaSn(BO₃)₂−xTiO₂ (x=0.2) was ground and polished.

### Example 5

A microwave dielectric ceramic (1−x)BaSn(BO₃)₂−xTiO₂ (x=0.25) in this example was prepared by a method as follows:
(1) Preparing raw materials: raw materials of B₂O₃(Macklin, 98%), SnO₂ (Macklin, 99.5%), and BaCO₃ (Macklin, 99%) were dried in an oven at 100° C. and then weighed according to the stoichiometric ratio.
(2) Mixing: a resulting prepared raw material, a zirconia ball, and absolute ethanol in a mass ratio of 1:3:2.5 were placed in a ball mill and wet ball milled at a rotation speed of 400 rpm for 6 h to obtain a raw material slurry.
(3) Drying: the raw material slurry obtained in step (2) was placed in an oven and then dried to a constant weight under a condition of 80° C. to obtain a dry mixed material.
(4) Pre-sintering: the dry mixed material obtained in step (3) was passed through an 80 mesh screen and then placed in a muffle furnace and pre-sintered at a temperature of 900° C. for 6 h to obtain a BaSn(BO₃)₂ powder.
(5) Ball milling: the BaSn(BO₃)₂ powder obtained in step (4) was added to absolute ethanol and placed in a ball mill, and subjected to secondary grinding at 400 rpm for 6 h to obtain a BaSn(BO₃)₂ slurry.
(6) Drying: the BaSn (BO₃)₂ slurry obtained in step (5) was placed in an oven and then dried to a constant weight under a condition of 80° C. to obtain a BaSn(BO₃)₂ powder.
(7) Solvent mixing: the BaSn(BO₃)₂ powder obtained in step (6) was passed through an 80 mesh standard sieve, and a resulting undersize material was mixed with TiO₂ in a mortar according to a ratio (1−x)BaSn(BO₃)₂−xTiO₂ (x=0.25). Then distilled water was added thereto, followed by full grinding of a resulting mixture until uniform, and then a resulting slurry was poured into a cylindrical mold.
(8) Sintering: the cylindrical mold obtained in step (7) was placed in a hot press and then sintered at a pressure of 550 MPa and a temperature of 270° C. for 30 min to obtain a (1−x)BaSn(BO₃)₂−xTiO₂ (x=0.25) microwave dielectric ceramic.
(9) Annealing: the (1−x)BaSn(BO₃)₂−xTiO₂ (x=0.25) ceramic obtained in step (8) was placed in a muffle furnace and maintained at 750° C. for 3 h, and then automatically cooled to room temperature.
(10) Postmechanical processing: a surface of a resulting sintered microwave dielectric ceramic (1−x) BaSn (BO₃)₂−xTiO₂ (x=0.25) was ground and polished.

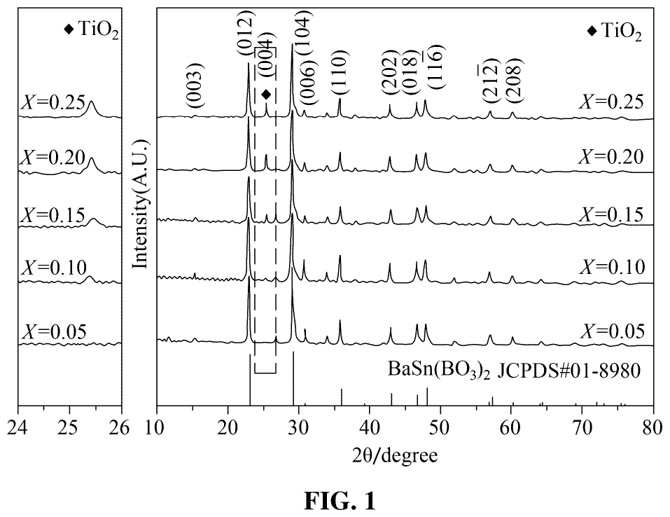

FIG. 1 shows the XRD patterns of the (1−x)BaSn(BO₃)₂−xTiO₂ microwave dielectric ceramics of Examples 1 to 5. As can be seen from FIG. 1, as the content of TiO₂ increases, the (004) diffraction peak of the TiO₂ phase is detected, and the intensity of the diffraction peak is gradually enhanced, while no diffraction peak of other phases is detected, which indicates that TiO₂ and BaSn(BO₃)₂ form a multiphase ceramic.

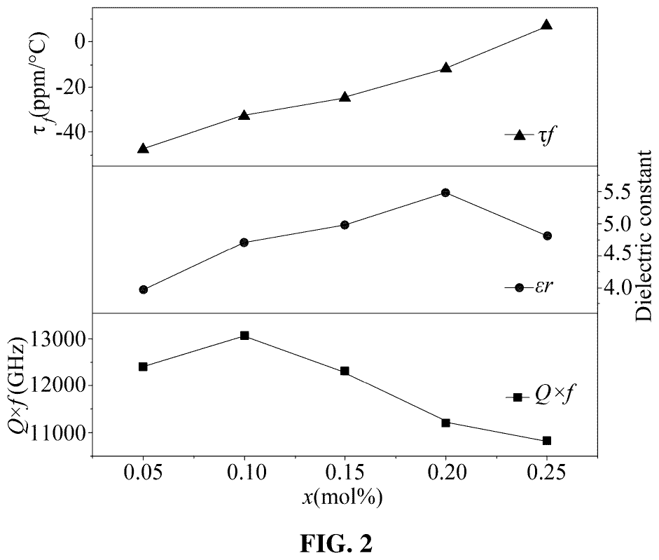

FIG. 2 shows the microwave dielectric property profiles of the (1−x) BaSn (BO₃)₂−xTiO₂ microwave dielectric ceramics of Examples 1 to 5. As can be seen from FIG. 2 that the microwave dielectric ceramics obtained in Examples 1 to 5 have a low dielectric constant (εᵣ) of 3.97, 4.71, 4.98, 5.48 and 4.81, respectively, and a quality factor (Q×f) of 12,426, 13,065, 12,323, 11,216 and 10,836, respectively; and a near-zero resonant frequency temperature coefficient (τ_{f}) of −48 ppm·° C.⁻¹, −33 ppm·° C.⁻¹, −25 ppm·° C.⁻¹, −12 ppm·° C.⁻¹, and +7 ppm·° C.⁻¹, respectively. As the content of TiO₂ increases, the value of εᵣ increases first and then decreases. When x=0.05, the value of εᵣ is 3.97, and the value of the dielectric constant is the smallest at this time. Then, the value of the εᵣ increases to its maximum of 5.48 at x=0.2, but still classified as a low dielectric-constant material. Likewise, as the content of TiO₂ increases first and then decreases, the value of (Q×f) reaches its maximum of 13,065 with a small amount of TiO₂ added (x=0.1) and then gradually decreases. The figure also shows the variation of the value of τ_{f} as a function of the addition amount of TiO₂. As can be seen, the negative τ_{f} value gradually increases to a near-zero value, when x=0.05, the value of τ_{f} is −48 ppm/° C., and when x=0.25, the value of τ_{f} is +7 ppm/° C., which enables a significant improvement in the temperature stability of the dielectric property of the samples.

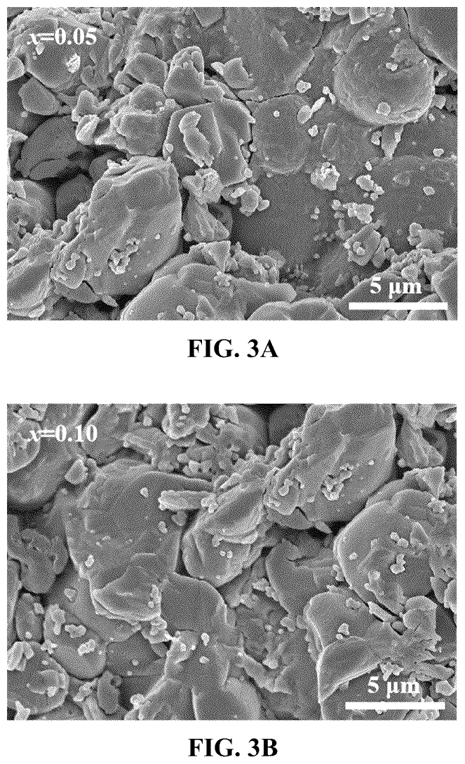

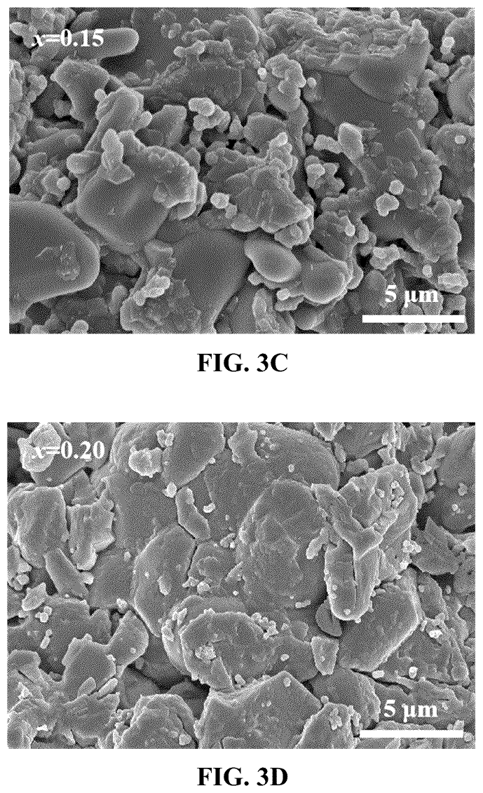

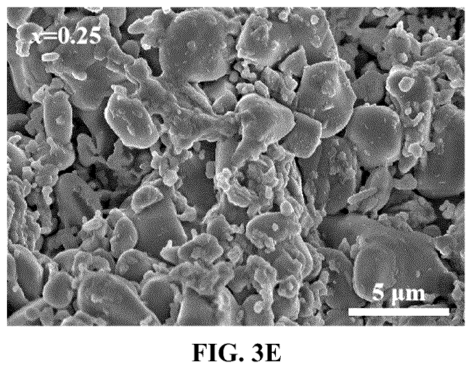

FIG. 3A to FIG. 3E show the scanning electron microscopy (SEM) images of the (1−x)BaSn(BO₃)₂−xTiO₂ microwave dielectric ceramics of Examples 1 to 5. As can be seen from FIG. 3A to FIG. 3E, when x=0.05, a small amount of fine crystals appear in the samples, which can fill the gaps and thus reduce the voids and increase the density of the samples. As the addition continues, that is, when x=0.15 to 0.25, the grain size of the samples decreases overall, more voids begin to appear, grain boundaries become blurred, and the dielectric property is also reduced accordingly.

The description above is only the preferred embodiments of the present disclosure. It should be noted that several improvements and modifications may also be made by those of ordinary skill in the art without departing from the principle of the present disclosure, these improvements and modifications should also be considered within the scope of the present disclosure.

What is claimed is:

1. A tin borate microwave dielectric ceramic with a near-zero temperature coefficient, having a chemical formula of (1−x)BaSn(BO₃)₂−xTiO₂, x being in a range of 0.05 to 0.25;
wherein a principal crystalline phase of the tin borate microwave dielectric ceramic with the near-zero temperature coefficient has a chemical formula of BaSn(BO₃)₂.

2. The tin borate microwave dielectric ceramic with the near-zero temperature coefficient of claim 1, wherein the tin borate microwave dielectric ceramic with the near-zero temperature coefficient has a resonant frequency temperature coefficient of −7 ppm·° C.⁻¹ to 7 ppm·° C.⁻¹, a dielectric constant of 3.97 to 5.48, and a quality factor of 10,836 to 13,065.

3. A method for preparing the tin borate microwave dielectric ceramic with the near-zero temperature coefficient of claim 1, the method comprising:
subjecting B₂O₃, SnO₂, and BaCO₃ to first mixing, and pre-sintering a resulting mixture to obtain a BaSn(BO₃)₂ powder; and
subjecting the BaSn(BO₃)₂ powder and TiO₂ to second mixing, and subjecting a resulting mixture to cold sintering and annealing in sequence to obtain the tin borate microwave dielectric ceramic with the near-zero temperature coefficient.

4. The method of claim 3, wherein the first mixing comprises conducting wet ball milling, drying, and sieving in sequence,
wherein the wet ball milling is conducted under parameters comprising:
a ratio of (i) a total mass of the B₂O₃, the SnO₂, and the BaCO₃, (ii) a mass of a zirconia ball, and (iii) a mass of absolute ethanol in a range of 1:3:2 to 1:3:2.8,
a rotation speed for the wet ball milling in a range of 380 rpm to 400 rpm, and
a time for the wet ball milling in a range of 6 hours to 8 hours.

5. The method of claim 3, wherein the pre-sintering is conducted at a temperature of 875° C. to 950° C. for 6 hours to 8 hours.

6. The method of claim 3, wherein before the second mixing, the method further comprises: subjecting the BaSn(BO₃)₂ powder to wet ball milling, drying, and sieving in sequence to obtain a undersize material passing through a screen.

7. The method of claim 3, wherein the second mixing comprises: mixing the BaSn(BO₃)₂ powder, the TiO₂, and water by grinding.

8. The method of claim 3, wherein the cold sintering is conducted at a temperature of 250° C. to 300° C. and a pressure of 450 MPa to 700 MPa for 25 minutes to 40 minutes.

9. The method of claim 3, wherein the annealing is conducted at a temperature of 600° C. to 750° C. for 2 hours to 4 hours.

10. The method of claim 3, wherein after the annealing, the method further comprises cooling a resulting annealed product to room temperature, and grinding and polishing the resulting annealed product.

11. The method of claim 3, wherein the tin borate microwave dielectric ceramic with the near-zero temperature coefficient has a resonant frequency temperature coefficient of −7 ppm·° C.⁻¹ to 7 ppm·° C.⁻¹, a dielectric constant of 3.97 to 5.48, and a quality factor of 10,836 to 13,065.

12. The method of claim 9, wherein after the annealing, the method further comprises cooling a resulting annealed product to room temperature, and grinding and polishing the resulting annealed product.
